(19) United States
(12) Patent Application Publication
(10) Pub. No.: US 2017/0277356 A1
(43) Pub. Date: Sep. 28, 2017

(54) Display

(71) Applicant: Incha Hsieh, Sinfon Township (TW)

(72) Inventor: Incha Hsieh, Sinfon Township (TW)

(21) Appl. No.: 15/618,250

(22) Filed: Jun. 9, 2017

Related U.S. Application Data
(63) Continuation-in-part of application No. 14/326,552, filed on Jul. 9, 2014.

(30) Foreign Application Priority Data
Jul. 15, 2013 (TW) 102125227

(51) Int. Cl. G06F 3/042; G02F 1/1362; G02F 1/1335; G02F 1/1333; G06F 3/041

(52) U.S. Cl. CPC G06F 3/0421; G02F 1/13338; G06F 3/0412; G02F 1/133512; G02F 1/136286; G02F 2201/40; G02F 2203/11

(57) ABSTRACT

A display includes a substrate, a photo-sensing unit, a sheltering unit and a light source unit. The substrate includes intersecting data lines and scan lines. The substrate has pixel zones, each being defined by adjacent two of the data lines and adjacent two of the scan lines. The photo-sensing unit includes infrared sensors disposed at positions corresponding to the scan lines or data lines. The sheltering unit is made of a material that allows transmission of infrared light therethrough and that blocks transmission of visible light therethrough, and fully covers the photo-sensing unit.

### CROSS-REFERENCE TO RELATED APPLICATION

This application is a continuation-in-part of U.S. patent application Ser. No. 14/326,552, filed on Jul. 9, 2014, the entire disclosure of which is incorporated herein by reference, and which claims priority of Taiwanese Patent Application No. 102125227, filed on Jul. 15, 2013.

### FIELD

The invention relates to a display, more particularly to a multi-functional display.

### BACKGROUND

When conventional displays are desired to be incorporated with gesture sensing/control functions, an add-on gesture sensor is required in order to perform such functions. For example, by plugging in an external gesture sensor, which includes a visible light camera, an infrared light source, and an infrared light detector to detect the infrared light generated by the infrared light source and reflected by an operator's gesture, the gesture sensing/controlling functions can thus be performed.

However, such configuration is not convenient and requires the external gesture sensor. Therefore, US Patent Application Publication No. 20100045811 discloses a conventional display, wherein infrared sensors are directly formed at pixel areas thereof, so that the add-on gesture sensors can be omitted. Nevertheless, the internal infrared sensors occupy the pixel areas and inevitably lower the aperture ratio of the conventional display.

### SUMMARY

Therefore, the object of the disclosure is to provide a display that can provide the infrared light-sensing function without lowering the aperture ratio thereof.

Accordingly, a display of the disclosure includes a substrate, a photo-sensing unit, a sheltering unit and a light source unit. The substrate includes a plurality of scan lines arranged along a first direction, and a plurality of data lines arranged along a second direction and intersecting the scan lines. The substrate has a plurality of pixel zones. Each of the pixel zones is cooperatively defined by adjacent two of the data lines and adjacent two of the scan lines. The photo-sensing unit is disposed on the substrate and includes a plurality of infrared sensors and a plurality of switches electrically coupled to the infrared sensors. The infrared sensors are disposed at positions corresponding to the data lines or the scan lines. The sheltering unit is made of a material which allows transmission of infrared light therethrough and which blocks transmission of visible light therethrough. The sheltering unit is formed to fully cover the photo-sensing unit. The light source unit is for image display.

### BRIEF DESCRIPTION OF THE DRAWINGS

Other features and advantages of the disclosure will become apparent in the following detailed description of the embodiment(s) with reference to the accompanying drawings, of which:

FIG. 1 is a fragmentary partly cutaway schematic perspective view of a first embodiment of a display according to the disclosure;

FIG. 2 is a fragmentary schematic view of the first embodiment, illustrating a layout structure of a first substrate;

FIG. 3 is a fragmentary schematic view of the first embodiment;

FIG. 4 is a schematic circuit diagram of the first embodiment;

FIG. 5 is a fragmentary schematic view of a variation of the first embodiment, illustrating the layout structure of the second substrate;

FIG. 6 is a fragmentary schematic view of another variation of the first embodiment, illustrating the layout structure of the second substrate;

FIG. 7 is a fragmentary schematic view of yet another variation of the first embodiment, illustrating the layout structure of the second substrate;

FIG. 8 is a schematic circuit diagram of yet another variation of the first embodiment, illustrating that the second substrate includes an amplifier;

FIG. 9 is a schematic diagram of the first embodiment, illustrating an arrangement of pixels;

FIG. 10 is a schematic diagram of the first embodiment, illustrating another arrangement of the pixels;

FIG. 11 is a perspective view of a second preferred embodiment of the display according to the disclosure;

FIG. 12 is a sectional view illustrating a third embodiment of the display according to the disclosure; and

FIG. 13 is a sectional view illustrating a variation of the third embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

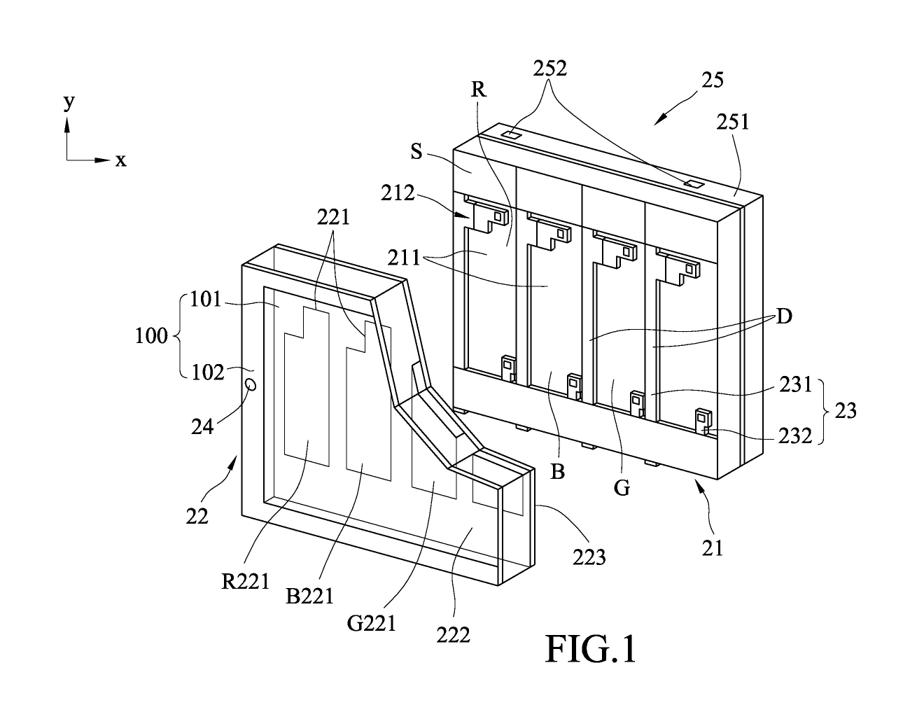

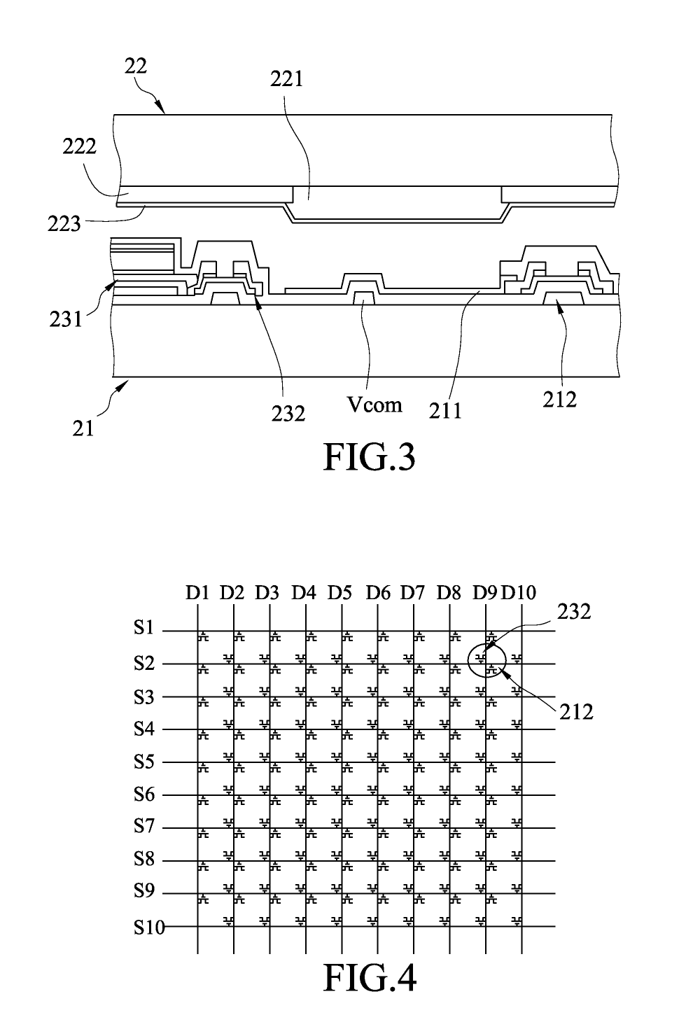

Referring to FIGS. 1 to 10, the first embodiment of a display according to the disclosure is shown to include a first substrate 21, a second substrate 22, a photo-sensing unit 23, a light generating unit 24, and a light source unit 25.

As shown in FIG. 1, the first substrate 21 includes a plurality of scan lines (S) arranged in a first direction (X), a plurality of data lines (D) arranged in a second direction (Y) and intersecting the scan lines (S), and a plurality of pixel zones cooperatively defined by an adjacent two of the scan lines (S) and an adjacent two of the data lines (D). Each of the pixel zones is provided with a pixel electrode 211 formed on the first substrate 21, and a switch 212. The switch 212 associated with a respective one of the pixel zones is operable to control an applied voltage to the respective one of the pixel zones via a respective one of the pixel electrodes 211. The switch 212 may be formed to either overlap or protrude from the corresponding scan line (S).

As shown in FIG. 1, the second substrate 22 is spaced apart from the first substrate 21 and has a display surface 100 defining a display zone 101 and a frame zone 102 surrounding the display zone 101. The second substrate 22 includes a common electrode 223 and a sheltering unit 222 (e.g., a black matrix in this embodiment) which is formed on a surface of the second substrate 22 opposite to the display surface 100 and which configures the second substrate 22 with a plurality of spaced-apart light-transmissible zones 221. The black matrix 222 is made of for example a pigment-based material so as to allow transmission of infrared light therethrough and to block transmission of visible light therethrough. Absorption spectrum of the black matrix 222 may be adjusted by adding different pigments with different absorption spectrums. The light-transmissible zones 221 correspond in position to the pixel zones of the first substrate 21 and allow transmission of visible light therethrough. In this embodiment, the second substrate 22 further includes a plurality of color filters disposed respectively at the light-transmissible zones 221 and including red light filters (R221) configured to allow transmission of red light therethrough, green light filters (G221) configured to allow transmission of green light therethrough, and blue light filters (B221) configured to allow transmission of blue light therethrough. The common electrode 223 covers the black matrix 222 and the color filters.

In general, the pixel zones of the first substrate 21 corresponding to the red light filters (R221) are defined as red pixels (R), the pixel zones corresponding to the green light filters (G221) are defined as green pixels (G), and the pixel zones corresponding to the blue light filters (B221) are defined as blue pixels (B).

It should be noted that the display of the embodiments are exemplified as a liquid crystal display (LCD), and liquid crystal molecules are filled between the first and second substrates 21, 22. However, the display of the disclosure is not limited to be configured as the LCD, and it can be configured as an organic LED (OLED) display, as well as an electro-wetting display, and should not be limited to what is disclosed in this embodiment.

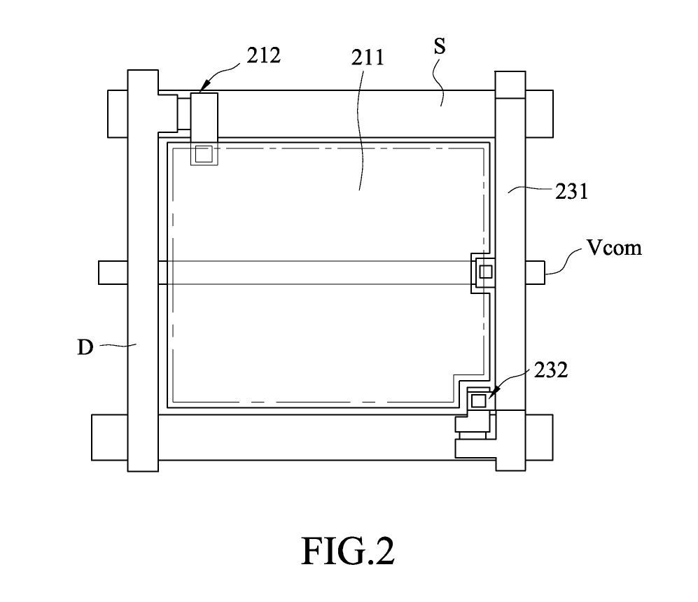

The photo-sensing unit 23 is disposed on the first substrate 21 at a position corresponding to the data lines (D) or on the scan lines (S), is excluded from being present in the pixel zones, and is fully covered by the black matrix 222 of the second substrate 22. To be specific, as shown in FIG. 2, a depicted central area of a pixel, which is defined by phantom lines, corresponds in position to one of the light-transmissive zones 221 of the second substrate 22. Excluded from the central area, a margin area, where the data lines (D) and the scan lines (S) are located, corresponds in position to the black matrix 222 of the second substrate 22. In this embodiment, the photo-sensing unit 23 includes a plurality of infrared sensors 231 and a plurality of switches 232 coupled to the infrared sensors 231, respectively. The infrared sensors 231 are operable to receive infrared light, which passes through the body of the black matrix 222 of the second substrate 22, so as to generate photo-currents. The photo-currents from the infrared sensors 231 can thus be converted into electrical signals by the switches 232, respectively.

Generally, the infrared sensors 231 can be photodiodes or phototransistors, and the switches 232, 212 can be thin film transistors (TFTs). Preferably, the switches 232, 212 can independently be indium-gallium-zinc-oxide (IGZO) transistors, polycrystalline silicon (Poly-Si) transistors, or amorphous silicon (a-Si) transistors. In one embodiment, each of the infrared sensors 231 is a photodiode made of a material selected from the group consisting of an a-Si semiconductor material, a micro-crystalline silicon semiconductor material, a Poly-Si semiconductor material, an organic material having a band gap less than 1.12 eV, and an inorganic material having a band gap less than 1.12 eV (such as HgCdTe). It should be noted that, when the infrared sensors 231 are desired to have effective sensitivity for light having a wavelength of 950 nm or greater, the infrared sensors 231 are preferably photodiodes made of the organic material or inorganic material having a band gap less than 1.12 eV (such as HgCdTe), since silicon-based photodiodes have relatively low sensitivity for the light having a wavelength of 950 nm or greater.

It is worth noting that, as shown in FIG. 2, the pixel electrodes 211 may share common voltage lines (Vcom) with the photo-sensing unit 23. However, in other embodiments, the pixel electrodes 211 may be coupled to one set of the common voltage lines (Vcom) and the photo-sensing unit 23 may be coupled to another set of common voltage lines (Vcom) different from those of the pixel electrodes 211.

It is worth noting that each of the switches 232 may share a single scan line (S) and a single data line (D) with the switch 212 associated with a common one of the pixel zones. In this case, the switches 232 and the switches 212 can be different types of TFTs, such as n-type TFTs and p-type TFTs, so as to prevent interference of reading and writing processes. For example, as shown in FIG. 4, when a pixel that corresponds to a scan line (S2) and a data line (D9) is in operation, an N-type TFT and a P-type TFT, which respectively serve as the switches 232, 212 associated with the respective one of the pixel zones, will be alternately conducted. That is, during positive half cycles of an alternating scan voltage applied to the scan line (S2), the P-type TFT (i.e., the switch 212) does not conduct and the N-type TFT (the switch 232) conducts to thereby allow the data line (D9) to read sensor signals (e.g., the photo-currents) generated by the corresponding infrared sensor 231. On the other hand, during negative half cycles of the alternating scan voltage, the N-type TFT does not conduct and the P-type TFT conducts to thereby allow the data line (D9) to write in the corresponding pixel electrode 211 a pixel voltage. In such configuration, Poly-Si TFTs are preferred since Poly-Si exhibits relatively high carrier mobility and is suitable for circuit patterns that require both N-type and P-type TFTs, and for products of small sizes (e.g., mobile phones) to gain higher aperture ratios.

Alternatively, each of the switches 232 and the switch 212 associated with a common one of the pixel zones may be independently coupled to various scan lines (S) or various data lines (D).

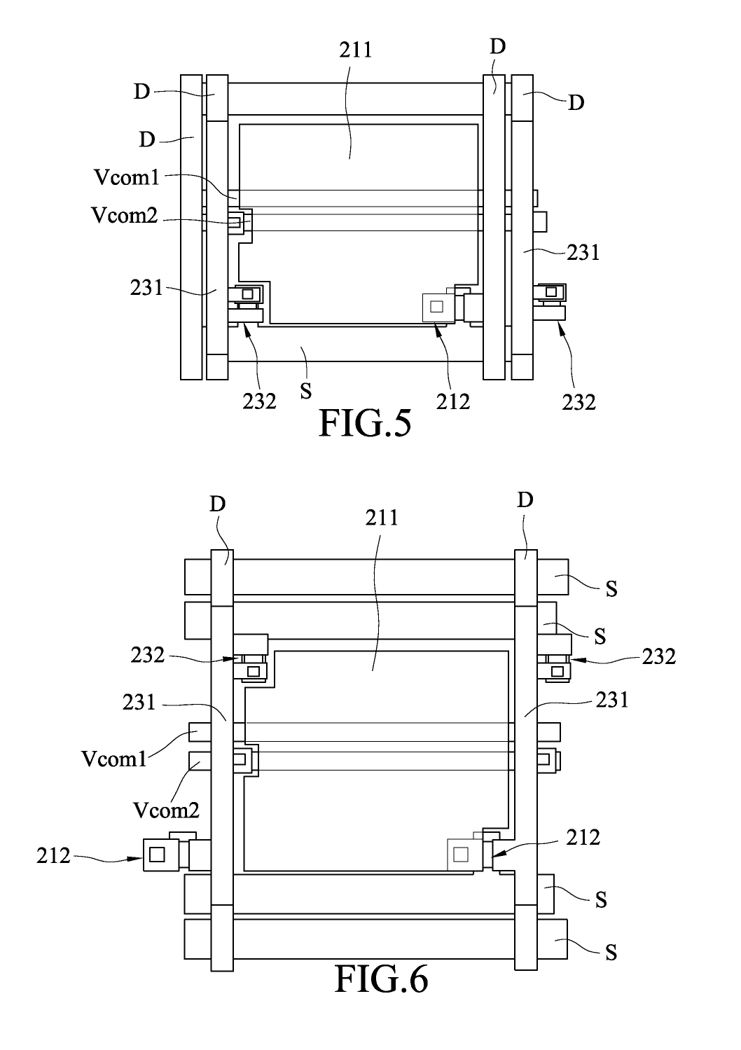

FIG. 5 illustrates a variation of the first embodiment of the display, wherein the switch 232 shares a single common scan line (S) with the switch 212 associated with the common one of the pixel zones, while being coupled to a different data line (D). In addition, as shown in FIG. 5, the pixel electrode 211 is coupled to a first common voltage line (Vcom1) and the photo-sensing unit 23 is coupled to a second common voltage line (Vcom2) different from that of the pixel electrode 211. When the scan line (S) is selected, the switches 212, 232 may simultaneously conduct (when the switches 212, 232 are of the same type of TFTs), and may respectively perform write operation and read operation through different data lines (D), respectively.

As shown in FIG. 6, another variation of the first embodiment of the display according to the disclosure is proposed, wherein the switch 232 shares a single common data line (D) with the switch 212 associated with adjacent one of the pixel zones, while being coupled to a different scan line (S). In addition, the pixel electrode 211 is coupled to the first common voltage line (Vcom1) and the photo-sensing unit 23 is coupled to the second common voltage line (Vcom2) different from that of the pixel electrode 211. Since each of the data lines (D) is shared by the switches 232, 212, read operation for the switch 232 and write operation for the switch 212 should be separated by use of the different scan lines (S) thereof.

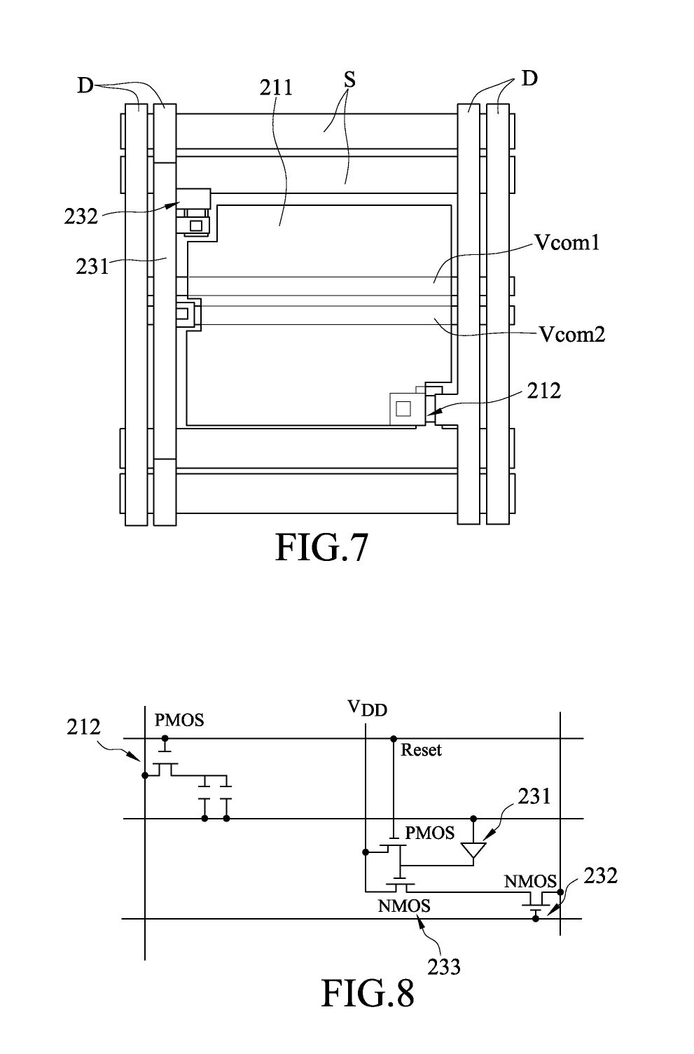

As shown in FIG. 7, yet another variation of the first embodiment of the display according to the disclosure is proposed, wherein the switch 232 does not share a single common data line (D) and a single common data line (S) with the switch 212 associated with the common one of the pixel zones. The pixel electrode 211 is coupled to the first common voltage line (Vcom1) and the photo-sensing unit 23 is coupled to the second common voltage line (Vcom2) different from that of the pixel electrode 211. Such configuration of using independent scan lines (S) and data lines (D) allows independent operations of the reading processes associated with the infrared sensors 231 and the writing processes associated with the pixel electrodes 211. Such configuration is suitable for devices having relatively large dimensions and using amorphous silicon (a-Si) TFTs. It is noted that, in the cases of FIGS. 5-7, types of the switch 232 and the switch 212 are not limited (i.e., can be both N-type TFTs or both P-type TFTs, or can be different) since each of the switches 212, 232 has an independent scan line (S) and/or an independent data line (D).

It should be noted that locations and the number of the infrared sensors 231 are adjustable based on size or sensitivity requirement of the display. For example, the infrared sensors 231 can be formed at positions corresponding to the scan lines (S) or on the data lines (D) which are located on one side of each of the pixels, or in configurations to surround each of one type of the pixels (such as the red pixels (R)), two adjacent pixels (such as a set of one of the red pixels (R) and an adjacent one of the green pixels (G)), or three adjacent pixels (such as one of the red pixels (R), an adjacent one of the green pixels (G) and an adjacent one of the blue pixels (B)). Since the data lines (D) and the scan lines (S) correspond in position to the black matrix 222, the infrared sensors 231 may have a relatively larger layout area without adversely affecting the aperture ratio of the display.

It should be noted that when the display has relatively large dimensions or the frequency of driving signals is relatively high (e.g., frame rate being higher than 60 Hz), the photo-sensing unit 23 of the display according to the disclosure can further include a plurality of amplifiers 233 operable for adjusting an output current of a corresponding one of the infrared sensors 231, so as to increase a signal-to-noise ratio of the infrared sensors 231 (see FIG. 8). The amplifiers 233 can be TFTs similar to those of the switches 232, 212.

The light generating unit 24 is disposed at a position corresponding to the frame zone 102 and can be coupled to one of the first and second substrates 21, 22. In this embodiment, the light-generating unit 24 serves as a light source for detection by the photo-sensing unit 23 and includes an infrared-light source and a lens component. The infrared light from the infrared-light source via the lens component is reflected by objects and then passes through the black matrix 222 to be received by the infrared sensors 231, so as to generate the sensor signals. The infrared-light source can be an infrared LED or an infrared laser.

The light source unit 25 is disposed at a side of the first substrate 21 opposite to the second substrate 22 and serves as a backlight of the display. In this embodiment, as shown in FIG. 1, the backlight unit 25 includes a light guide plate 251 and a plurality of light sources 252 that are disposed on sides or surfaces of the light guide plate 251 and that are operatively associated with the light plate 251. In this embodiment, each of the light sources 252 can be selected from the group consisting of a white LED, a red LED, a green LED, a blue LED, and a far infrared LED. The aforesaid white, red, green or blue LEDs may contain phosphors emitting infrared light upon excitation.

By arranging the infrared sensors 231 of the photo-sensing unit 23 at positions corresponding to the black matrix 222 of the second substrate 22, the infrared-light sensing function can be built into the display and layout areas of the infrared sensors 231 can be increased without lowering the aperture ratio of the display. Moreover, sensitivity of the infrared sensors 231 is not adversely affected by the ambient light or backlight owing to the black matrix 222. Furthermore, when the infrared sensors 231 of the photo-sensing unit 23 are photodiodes (such as PIN junctions) and are disposed below the black matrix 222, the infrared sensors 231 can store electrical energy as capacitors to provide electrical power for other components of the display.

It is worth noting that the infrared sensors 231 can be configured into various sets of independent infrared cameras using software, so as to simultaneously detect multiple objects without mutual interference.

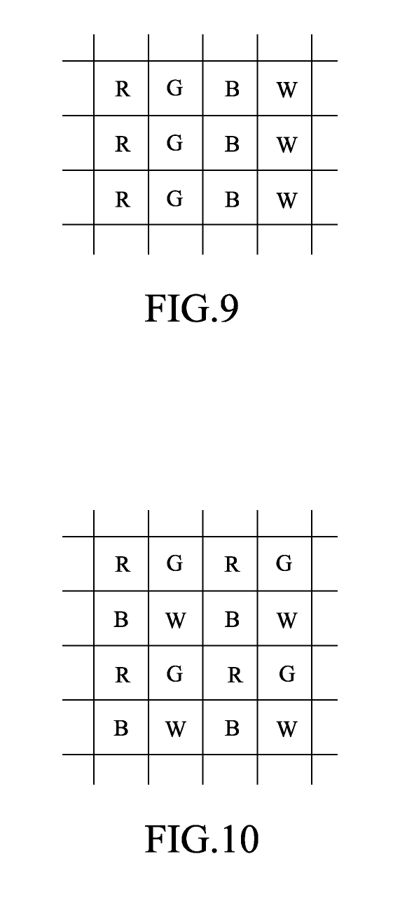

It is worth noting that some of the light-transmissible zones 221 of the second substrate 22 may be provided with no color filters to allow a whole spectrum of visible light to pass therethrough. Such light-transmissible zones 221 can be defined as white pixels (W) and are operable to adjust a brightness level of the display. As shown in FIGS. 9 and 10, various exemplary arrangements of the white pixels (W), the red pixels (R), the green pixels (G), and the blue pixels (B) are illustrated.

It is worth noting that the display of the disclosure is not limited to be implemented as a conventional display or a gesture sensing/control display. Since the infrared sensors 231 can be arranged in accordance with the pixel zones and since the display includes the light generating unit 24 and the light source unit 25, the display of the disclosure can also be implemented as a scanner, an infrared display, or a night vision display based on demands of various fields.

It is worth noting that when the color filters are omitted from the display, the display may still perform image display function but in a grey scale configuration. In other embodiments of the disclosure, photo-sensors operable to detect various colors of light may be incorporated into the corresponding pixel zones (such as red, blue, and green pixels), so as to perform color-image sensing functions.

It is also worth noting that, in this embodiment, the display may further include an X-ray sensing unit which is coupled to the first substrate, and which includes a plurality of scintillators operable to convert X-ray light into visible light, and a plurality of TFTs operable to convert the visible light from the scintillators into electrical signals. By virtue of such, the display of the disclosure can be incorporated with X-ray sensing/display functions. In greater detail, the scintillators can be configured as rods that are made of a scintillation material such as CsI. Since CsI can convert X-ray into light having a wavelength substantially ranging from 520 nm to 570 nm (i.e., in a range of green light), the X-ray sensing unit can be accordingly disposed at positions corresponding to the green pixels (G) or the pixels (W) which allow transmission of light in such range of wavelength.

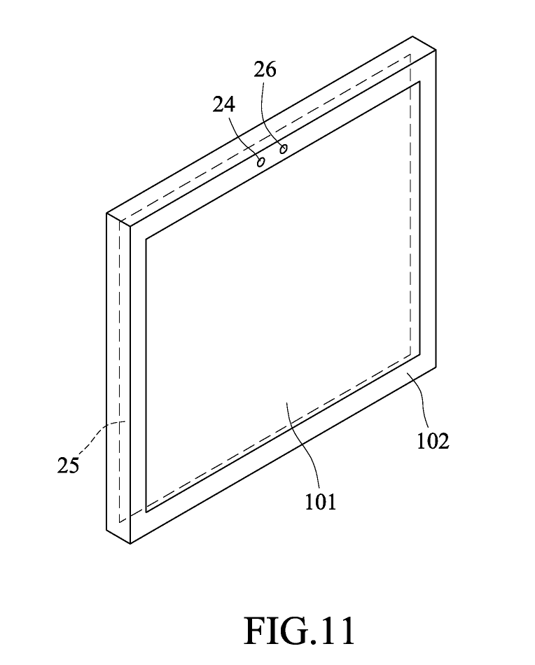

Referring to FIG. 11, the second embodiment of the display according to the disclosure is shown to be similar to that of the first embodiment. The difference therebetween resides in that the display of the second embodiment further includes a micro projector 26. The micro projector 26 may be coupled to one of the first and second substrates 21, 22 and is operable for projecting images. In this embodiment, the micro projector 26 is disposed at a position corresponding to the frame zone 102 of the second substrate 22. In addition, the micro projector 26 may cooperate with the photo-sensing unit 23 and the light generating unit 24 to perform the gesture sensing function. For example, as shown in FIG. 11, both of the light generating unit 24 and the micro projector 26 may be disposed on a top portion of the frame zone 102 and the micro projector 26 projects a two-dimensional image onto a surface (or a three-dimensional image), which serves as an optically projected input/control interface (like a virtual keyboard or a virtual mouse). When an object (such as a finger) performs an input movement (such as typing), the infrared light from the light generating unit 24 is reflected by the gesture of the object, so as to be detected by the photo-sensing unit 23. It should be noted that the micro projector 26 may be rotatably coupled to one of the first and second substrates 21, 22, so that the position of the projected image is adjustable.

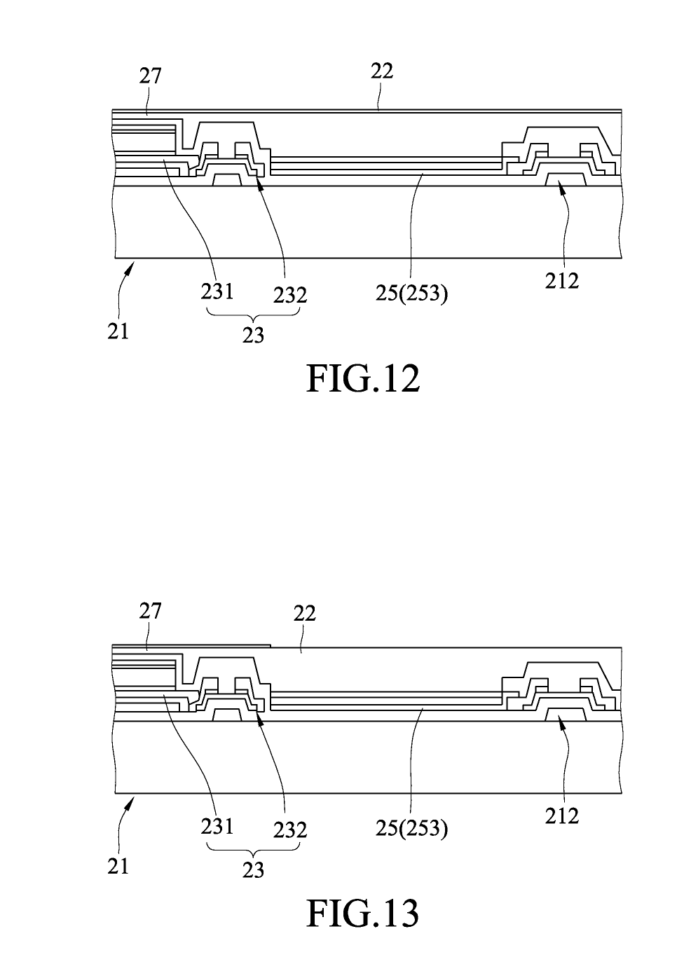

The third embodiment of the display according to the disclosure is realized in a form of an OLED display. In one implementation of this embodiment, the light source unit is an organic electro-luminescence layer which may be formed by different organic materials for light emission of different colors (e.g., red color, blue color, green color, etc.) so that the display can present various colors without using a color filter (see FIG. 12). In FIG. 12, the light source unit 25 includes an organic electro-luminescence layer 253 that is formed at positions corresponding to the pixel zones with different electro-luminescence materials for light emission of different wavelengths (e.g., red color, blue light, green light, infrared light, etc.); and the display includes a sheltering unit 27, which may be made of for example a pigment-based material, and which is formed on the first substrate 21 at positions corresponding to and over the photo-sensing unit 23 to directly and fully cover the photo-sensing unit 23, thereby achieving the same effect as the black matrix described in the first and second embodiments (i.e., the body of the sheltering unit 27 allowing transmission of infrared light therethrough for detection by the photo-sensing unit 23 and blocking transmission of visible light therethrough). It is noted that the second substrate 22 may be made of a glass material or a macromolecular material in a form of a cover plate or a coating layer that covers the first substrate 21. It is further noted that, in this case, the sheltering unit 27 may be formed on a surface of the second substrate 22 opposite to the first substrate 21 at positions corresponding to the photo-sensing unit 23 to fully cover the photo-sensing unit 23, as shown in FIG. 13. In FIG. 13, the second substrate 22 is formed as a layer on the first substrate 21, and may be made of a light transmissive polymer, such as Poly(methyl methacrylate) (PMMA).

In one implementation of this embodiment, the light source unit is an organic electro-luminescence layer which may be formed by an organic material for light emission of white color, and which cooperates with a color filter so that the display can present various colors. In one implementation of this embodiment, the light source unit includes an organic electro-luminescence layer which may be formed by an organic material for light emission of blue color, and a color conversion layer to convert the blue light into different colors, so that the display can present various colors. In the implementations that require the color filter or the color conversion layer to present various colors, the sheltering unit may be implemented as the black matrix described for the first and second embodiments.

To sum up, by arranging the infrared sensors 231 of the photo-sensing unit 23 at positions corresponding to the black matrix 222 of the second substrate 22 and by the intrinsic properties of the black matrix 222 allowing transmission of infrared light, the infrared-light sensing function can be incorporated into the display of the disclosure and the infrared sensors 231 can have relatively large layout areas while maintaining a relatively high aperture ratio. Moreover, sensitivity of the infrared sensors 231 is not adversely affected by ambient visible light or backlight owing to the black matrix 222 which blocks transmission of the visible light therethrough. Furthermore, the number and the layout areas of the infrared sensors 231 are adjustable based on the size of the display and the sensitivity requirement for the infrared detecting function of the display. Even further, by including the functional components such as the X-ray sensing unit and the micro projector 26, the display of the disclosure can be incorporated with various functions, such as gesture-sensing/control, X-ray sensing/display, infrared thermal imaging, night vision display or the like, based on functional demands in various fields.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A display comprising:
a first substrate that includes a plurality of scan lines arranged along a first direction, and a plurality of data lines arranged along a second direction and intersecting said scan lines, said first substrate having a plurality of pixel zones, each of said pixel zones being cooperatively defined by adjacent two of said data lines and adjacent two of said scan lines;
a photo-sensing unit that is disposed on said first substrate and that includes a plurality of infrared sensors and a plurality of first switches electrically coupled to said infrared sensors, said infrared sensors being disposed at positions corresponding to said data lines or said scan lines;
a sheltering unit that is made of a material which allows transmission of infrared light therethrough and which blocks transmission of visible light therethrough, said sheltering unit being formed to fully cover said photo-sensing unit; and
a light source unit for image display.

2. The display of claim 1, wherein said light source unit is formed at positions corresponding to said pixel zones, and is made of at least one electro-luminescence material.

3. The display of claim 2, further comprising a second substrate covering said first substrate such that said scan lines and said data lines are disposed between said first and second substrates.

4. The display of claim 3, wherein said sheltering unit is formed on said first substrate to directly cover said photo-sensing unit.

5. The display of claim 3, wherein said sheltering unit is formed on said second substrate to cover said photo-sensing unit.

6. The display of claim 5, wherein said sheltering unit is formed on a surface of said second substrate opposite to said first substrate.

7. The display of claim 2, wherein said sheltering unit is formed on said first substrate to directly cover said photo-sensing unit.

8. The display of claim 2, wherein said light source unit is made of a plurality of electro-luminescence materials configured to emit light of different colors.

9. The display of claim 1, wherein said sheltering unit is formed on said first substrate to directly cover said photo-sensing unit.
